SEQUENCE LISTING (5 sequences)

SEQ ID NO: 1 - protein, 378 aa, Aspergillus oryzae
MGVNFKVLALSALATISHASPLLYPRATDSNVTYVFTNPNGLNFTQMNTTLPNVTIFATGGTIAGSSADNTATTGYKAGAVGIQTLIDAVPEMLNVANVAGVQVTNVGSPDITSDILLRLSKQINEVVCNDPTMAGAVVTHGTDTLEESAFFLDATVNCRKPVVIVGAMRPSTAISADGPLNLLQSVTVAASPKARDRGALIVMNDRIVSAFYASKTNANTVDTFKAIEMGNLGEVVSNKPYFFYPPVKPTGKTEVDIRNITSIPRVDILYSYEDMHNDTLYSAIDNGAKGIVIAGSGSGSVSTPFSAAMEDITTKHNIPIVASTRTGNGEVPSSAESSQIASGYLNPAKSRVLLGLLLAQGKSIEEMRAVFERIGVA

SEQ ID NO: 2 - protein, 326 aa, Pyrococcus furiosus
MKILLIGMGGTIASVKGENGYEASLSVKEVLDIAGIKDCEDCDFLDLKNVDSTLIQPEDWVDLAETLYKNVKKYDGIIVTHGTDTLAYTSSMISFMLRNPPIPIVFTGSMIPATEENSDAPLNLQTAIKFATSGIRGVYVAFNGKVMLGVRTSKVRTMSRDAFESINYPIIAELRGEDLVVNFIPKFNNGEVTLDLRHDPKVLVIKLIPGLSGDIFRAAVELGYRGIVIEGYGAGGIPYRGSDLLQTIEELSKEIPIVMTTQAMYDGVDLTRYKVGRLALRAGVIPAGDMTKEATVTKLMWILGHTNNVEEIKVLMRKNLVGELRD

SEQ ID NO: 3 - protein, 331 aa, Thermococcus sibiricus
MKKLLIIGTGGTIASAKTEQGYKSVLKIDEILKLAKIKLENGYKIDSTNIMNIDSTLIHPEDWEIIAKEVFKALDDYDGIIITHGTDTLAYTASMLSFMIKNPNKPIVLTGSMLPITENGSDAPRNIRTAIKFAMEDVAGVFVAFMDKIMLGCRTSKVRTLGLNAFMSINYPDVAYVKGEKILYNIPKEKFQPNGSPELDTKYEPRVVVLRVTPGLGGEIIDAVLDAGYKGIVLEGYGAGGLPYRKSNLLSKIKEITPKIPVIMTTQALYDGVDMRKYEVGRKALETGIIPAKDMTKEATITKLMWALGHTKDVEKIREIMHTNYVNEIKS

SEQ ID NO: 4 - protein, 328 aa, Thermococcus gammatolerans
MRILIIGTGGTIASSKTERGYKATLSVDEILEIAGIRGDGVKIDTKDVLNIDSTLIQPEDWITIGKAVFESLNDYDGIVITHGTDTLAYTSSALSFMLRNVPIPIVLTGSMLPITEPNSDAPRNLKTALTFAMKGFSGIYVAFMDKIMLGTRVSKVHSLGLNAFQSINYPDIAYIKGEEVVIRHRPELPTGEPSFDPRIDPNVAYLRLTPGLSPEVFLAVAEKVHGIVLEGYGAGGIPYRGRNLLEAVSRVAREKPVVMTTQALYGGVDLRRYEVGRRALEAGVIPAGDMTKEATLVKLMYALGRTNGLEEVRRIMEKNLAGELSSAF

SEQ ID NO: 5 - protein, 328 aa, Thermococcus kodakaraensis
MKLLVLGTGGTIASAKTEMGYKAALSADDILQLAGIRREDGAKIETRDILNLDSTLIQPEDWVTIGRAVFEAFDEYDGIVITHGTDTLAYTSSALSFMIRNPPIPVVLTGSMLPITEPNSDAPRNLRTALTFARKGFPGIYVAFMDKIMLGTRVSKVHSLGLNAFQSINYPDIAYVKGDEVLVRHKPRIGNGEPLFDPELDPNVVHIRLTPGLSPEVLRAVARATDGIVLEGYGAGGIPYRGRNLLEVVSETAREKPVVMTTQALYGGVDLTRYEVGRRALEAGVIPAGDMTKEATLTKLMWALGHTRDLEEIRKIMERNIAGEITGS

(19) United States
(12) Patent Application Publication
(10) Pub. No.: US 2016/0037807 A1
(43) Pub. Date: Feb. 11, 2016

(54) Method for Reducing the Level of Asparagine in a Food Material

(71) Applicant: Novozymes A/S, Bagsvaerd (DK)

(72) Inventors: Hanne Vang Hendriksen, Holte (DK); Katja Puder, Copenhagen (DK); Anne Goldbech Olsen, Valby (DK)

(73) Assignee: Novozymes A/S, Bagsvaerd (DK)

(21) Appl. No.: 14/781,760

(22) PCT Filed: Apr. 3, 2014
(86) PCT No.: PCT/EP2014/056688

§ 371 Date: Oct. 1, 2015

(30) Foreign Application Priority Data
Apr. 5, 2013 (EP) 13162493.4

(51) Int. Cl. A23L 1/015; A23F 5/02; A23F 5/16; A23L 1/217

(52) U.S. Cl. CPC A23L 1/0153; A23L 1/217; A23F 5/02; A23F 5/163; A23V 2002/00

(57) ABSTRACT

The present invention relates to a method for reducing the level of asparagine in a food material to be heat-treated comprising soaking the food material in water and contacting at least part of the soaking water with an immobilized asparaginase.

### REFERENCE TO SEQUENCE LISTING

This application contains a Sequence Listing in computer readable form. The computer readable form is incorporated herein by reference.

### FIELD OF THE INVENTION

The present invention relates to a method for reducing the level of asparagine in a food material to be heat-treated.

### BACKGROUND OF THE INVENTION

It is well known that acrylamide formation in heated food products can be reduced by a treatment reducing the amount of asparagine in the food materials, such as by subjecting the food materials to the action of the enzyme asparaginase (see e.g. WO2004/026042).

Thermostable asparaginase can be used for the treatment of, e.g., sliced potato chips or coffee beans (WO2008/151807).

However, if asparaginase is used, e.g., during blanching of sliced potato chips, the very short process time used to ensure final product quality, means that a very high enzyme dosage is needed. Also a high amount of fresh water may continuously be added to the blanching water to keep glucose and fructose concentrations at an acceptable level, which means that active asparaginase is washed out.

It is an object for the present inventors to provide a method for reducing the level of asparagine in, e.g., sliced potatoes for potato chips where asparaginase is used at an industrially acceptable dosage.

### SUMMARY OF THE INVENTION

The present inventors have found that during blanching of potato pieces in hot water, if immobilized asparaginase is added to the blanching water, the amount of free asparagine in the water is decreased. This shows that immobilized asaparaginase is active in the hot blanching water.

Use of immobilized asparaginase as compared to free asparaginase enables more re-use of the soaking/blanching water comprising the asparaginase. Thus, even if a higher dosage of immobilized asparaginase is required to obtain the same level of asparagine turnover, the re-use of the enzyme will allow for treatment of, e.g., more batches of sliced potatoes per mg of enzyme protein.

The inventors have provided a method where immobilized asparaginase is used at a temperature where microbial growth is reduced, i.e. at low temperature or high temperature. This is a major advantage in the food industry where microbial growth at any stage is detrimental.

The present invention relates to a method for reducing the level of asparagine in a food material to be heat-treated comprising:

(a) soaking the food material in water to extract asparagine;
(b) contacting at least part of the soaking water comprising asparagine with an immobilized asparaginase at a temperature where microbial growth is reduced; and
(c) re-using at least part of the asparaginase treated soaking water.

The inventors have found that combining this method with a glucose and/or fructose removing technology will enable even more re-use of the blanching water. This would result in significant savings in heating of fresh water.

Therefore, in one preferred embodiment, the soaking water comprising asparagine is contacted with an immobilized asparaginase and with an immobilized enzyme having a glucose oxidising activity at a temperature where microbial growth is reduced.

The inventors have successfully immobilized a thermostable asparaginase and found that use of a thermostable asparaginase in immobilized form is an advantage in certain industrial applications where the contacting with the enzyme is preferably to take place at high temperature.

Therefore, in another preferred embodiment, the invention relates to a method for reducing the level of asparagine in a food material to be heat-treated comprising:

(a) soaking the food material in water at a temperature of above 60° C., preferably above 65° C., more preferably above 70° C., even more preferably at a temperature of at least 75° C. or at least 80° C., to extract asparagine;
(b) contacting at least part of the soaking water comprising asparagine with an immobilized thermostable asparaginase at a temperature of above 60° C., preferably above 65° C., more preferably above 70° C., even more preferably at a temperature of at least 75° C. or at least 80° C.; and
(c) re-using at least part of the asparaginase treated soaking water.

In such method, soaking may also be referred to as blanching.

The inventors have surprisingly found that immobilized asparaginase can be used for continuous treatment of more than 3.5 tons of soaking water per kg asparaginase without any measurable loss of activity. Further, very little enzyme was leaking from the immobilized product. It is established knowledge in the art that not all enzymes can be successfully immobilized.

Therefore, in another preferred embodiment, the invention relates to a method for reducing the level of asparagine in a food material to be heat-treated comprising:

(a) soaking the food material in water to extract asparagine;
(b) contacting at least part of the soaking water comprising asparagine with an immobilized asparaginase at a temperature where microbial growth is reduced; and
(c) re-using at least part of the asparaginase treated soaking water;
wherein the immobilized asparaginase is used for continuous treatment of more than 2 tons of soaking water per kg asparaginase, preferably more than 3 tons of soaking water per kg asparaginase, more preferably more than 4 tons or more than 5 tons of soaking water per kg asparaginase.

In one preferred embodiment, the invention relates to a method for reducing the level of asparagine in potato slices, which are to be fried or baked to produce potato chips, comprising:

(a) soaking the potato slices in water at a temperature of above 60° C., preferably above 65° C., more preferably above 70° C., even more preferably at a temperature of at least 75° C. or at least 80° C., to extract asparagine;
(b) pumping at least part of the soaking water through a bed or column of immobilized thermostable asparaginase at a temperature of above 60° C., preferably above 65° C., more preferably above 70° C., even more preferably at a temperature of at least 75° C. or at least 80° C.; and
(c) re-using at least part of the asparaginase treated soaking water to soak further batches of potato slices;
wherein the immobilized asparaginase is used for continuous treatment of more than 2 tons of soaking water per kg asparaginase, preferably more than 3 tons of soaking water per kg asparaginase, more preferably more than 4 tons or more than 5 tons of soaking water per kg asparaginase.

### DETAILED DESCRIPTION OF THE INVENTION

The invention provides a method for reducing the level of asparagine in a food material to be heat-treated comprising:

(a) soaking the food material in water to extract asparagine;
(b) contacting at least part of the soaking water comprising asparagine with an immobilized asparaginase at a temperature where microbial growth is reduced; and
(c) re-using at least part of the asparaginase treated soaking water.

The food material to be used in the method is a food material which is to be heat treated. The heat treatment is a part of the production of a heat-treated food product from the food material.

A food product according to the invention is any nutritious substance that people eat or drink. For the avoidance of any possible doubt, this includes roasted coffee beans.

In a conventional method, i.e., a method without extraction of asparagine from the food material and subsequent degradation of the asparagine by immobilized asparaginase, more acrylamide would be formed during the heat treatment as compared to heat treatment of a food material which has been subjected to the method of the invention.

Preferred heating steps are those at which at least a part of the food material, e.g., the surface of the food material, is exposed to temperatures at which the formation of acrylamide is promoted, e.g. 110° C. or higher, or 120° C. or higher. The heat treatment may involve, e.g., frying, baking, toasting or roasting. The heat treatment may be carried out in ovens, for instance at a temperature of 180-250° C., or in oil such as the frying of potato pieces to produce potato chips or French fries, for example at 160-195° C. Or it may be carried out by toasting or roasting, such as by roasting of coffee beans.

The food material which is to be soaked in water according to the method of the invention may be any raw material which is to be included in a food product, or it may be any intermediate form of a food product which occurs during the production process prior to heat treatment. It may be any individual raw material used and/or any mixture thereof and/or any mixture thereof also including additives and/or processing aids, and/or any subsequently processed form thereof.

The food material may be of plant origin, for example a vegetable tuber or root, such as but not limited to the group consisting of potato, carrot, beetroot, parsnip, parsley root, celery root, sweet potato, yams, yam bean, Jerusalem artichoke, radish, turnip, chicory root and cassava potato; a cereal, such as but not limited to the group consisting of wheat, rice, corn, maize, rye, barley, buckwheat, sorghum and oats; coffee; cocoa; chicory; olives; prunes or raisins. It may be a mixture of more than one raw material.

Raw materials as cited above are known to contain substantial amounts of asparagine which is involved in the formation of acrylamide during heat treatment.

The food material is soaked in water. It is to be understood that the water does not necessarily have to be pure water. It may be an aqueous solution of one or more salts, e.g., a buffer. Or it may be water which has previously been used for the soaking of other batches of food material, in which case the water will comprise soluble materials extracted from the food material, e.g., salt, glucose, amino acids, etc.

The soaking is carried out at high temperature, e.g., at a temperature of above 60° C., preferably above 65° C., more preferably above 70° C., even more preferably at a temperature of at least 75° C. or at least 80° C., or at low temperature, e.g., at a temperature of below 15° C., preferably below 12° C., more preferably below 10° C. If carried out at high temperature, the soaking may be referred to as blanching. The blanching may be at an even higher temperature, e.g., at a temperature of about 85-100° C.

During the soaking in water, asparagine is extracted from the food material. The soaking water comprising asparagine is contacted with an immobilized asparaginase. The immobilized asparaginase converts asparagine to aspartic acid, thus creating a driving force for additional asparagine extraction on subsequent additions of batches of food material to the same soaking water.

Extractable materials in the soaking water can equilibrate with the food material such that additional soluble components of the food material do not extract out, with the exception of asparagine, which is continuously converted by the immobilized asparaginase. The aspartic acid that is formed from the asparagine may soak back into the food material and equilibrate.

In the method of the invention, the soaking water comprising asparagine is contacted with an immobilized asparaginase.

The asparaginase may have been immobilized by any means known in the art. It may have been adsorbed, crosslinked or covalently bonded to a carrier, preferably an inert carrier. In a preferred embodiment, the asparaginase has been immobilized by crosslinking with glutaraldehyde on a carrier, preferably a carrier having a size of 50-1500 micron. The asparaginase may have been immobilized by one of the methods mentioned in WO2007/036235, e.g., by the method described in Example 2 of WO2007/036235.

The soaking water comprising asparagine is contacted with an immobilized asparaginase at a temperature where microbial growth is reduced.

In a preferred embodiment, the contacting in step (b) is performed at a temperature where microbial growth is at least 50% reduced compared to 37° C.

In another preferred embodiment, the contacting in step (b) is performed at a temperature of below 15° C. or above 60° C., preferably below 12° C. or above 70° C., more preferably below 10° C. or above 80° C.

In another preferred embodiment, the contacting in step (b) is performed at a temperature of above 60° C., preferably above 65° C., more preferably above 70° C., even more preferably at a temperature of at least 75° C. or at least 80° C. In one embodiment, the contacting in step (b) is performed at a temperature of 60-100° C., preferably 70-100° C., more preferably 80-100° C. In another embodiment, the contacting in step (b) is performed at a temperature of 60-95° C., preferably 70-95° C., more preferably 80-95° C. In one embodiment, a thermostable asparaginase is used. However, a less thermostable asparaginase may also be used since such asparaginase will likely be more stable when immobilized than in free form.

In another preferred embodiment, a thermostable asparaginase is used and the contacting in step (b) is performed at a temperature of about 75-100° C., preferable 80-100° C., more preferably 80-95° C.

In another preferred embodiment, the contacting in step (b) is performed at a temperature of below 15° C., preferably below 12° C., more preferably below 10° C. In one embodiment, the contacting in step (b) is performed at a temperature of 0-15° C., preferably 0-12° C., more preferably 0-10° C. In another embodiment, the contacting in step (b) is performed at a temperature of 3-15° C., preferably 3-12° C., more preferably 3-10° C.

In a preferred embodiment, the immobilized asparaginase is used for continuous treatment of more than 2 tons of soaking water per kg asparaginase, preferably more than 3 tons of soaking water per kg asparaginase, more preferably more than 4 tons or more than 5 tons of soaking water per kg asparaginase.

In one embodiment, the food material to be soaked in water comprises cuts of potatoes or other root vegetables such as, but not limited to, carrot, beetroot, parsnip, parsley root and celery root, which are to be fried and/or baked. Examples of food products made from such food material are French fries, sliced potato chips and sliced chips from root vegetables such as, but not limited to, carrot, beetroot, parsnip, parsley root and celery root. The food material to be soaked in water may be cuts of potatoes or other root vegetables which have optionally been peeled. Preferably, the soaking in water of such food material is performed at a temperature of above 60° C., preferably above 65° C., more preferably above 70° C., even more preferably at a temperature of at least 75° C. or at least 80° C. Soaking at such high temperature is in effect a blanching of the cuts of potatoes or other root vegetables.

In one embodiment, the food material comprises cuts of potatoes or other root vegetables such as, but not limited to, carrot, beetroot, parsnip, parsley root and celery root, which are to be fried and/or baked; step (a) is soaking of the cuts of potatoes or other root vegetables at a temperature of above 60° C., preferably above 65° C., more preferably above 70° C., even more preferably at a temperature of at least 75° C. or at least 80° C.; and step (b) is contacting of at least part of the soaking water comprising asparagine with an immobilized asparaginase, such as an immobilized thermostable asparaginase, at a temperature of above 60° C., preferably above 65° C., more preferably above 70° C., even more preferably at a temperature of at least 75° C. or at least 80° C.

The soaking in step (a) and the contacting of the soaking water with immobilized asparaginase in step (b) may be performed at the same time and in the same container. Since asparagine will thus continuously be removed from the soaking water, the soaking water can be re-used to a larger extent for the soaking of further batches of food material, which will result in savings in heating of fresh water. In this case, step (c) is re-use of at least part of the soaking water comprising the immobilized asparaginase to soak several batches of food material.

Alternatively, step (b) is pumping of at least part of the soaking water through a bed or column of immobilized asparaginase at a temperature of above 60° C., preferably above 65° C., more preferably above 70° C., even more preferably at a temperature of at least 75° C. or at least 80° C.

In this case, at least part of the asparaginase treated soaking water is added back to the container used for soaking. The soaking water comprising a reduced amount of asparagine can then be used for the soaking of further batches of food material. Which again results in savings in heating of fresh water. Thus, step (c) is re-use of at least part of the asparaginase treated soaking water to soak further batches of food material.

In one embodiment, the food material is potato pieces, such as potato slices or potato strips, which are to be fried or baked to produce potato chips or French fries.

In another embodiment, the food material is potato pieces, such as potato slices or potato strips, which are to be fried or baked to produce potato chips or French fries, step (a) is soaking of the potato pieces at a temperature of above 60° C., preferably above 65° C., more preferably above 70° C., even more preferably at a temperature of at least 75° C. or at least 80° C., and step (b) is contacting of at least part of the soaking water comprising asparagine with an immobilized asparaginase, such as an immobilized thermostable asparaginase, at a temperature of above 60° C., preferably above 65° C., more preferably above 70° C., even more preferably at a temperature of at least 75° C. or at least 80° C. In one preferred embodiment, the soaking of the potato pieces in step (a) and the contacting of the soaking water with immobilized asparaginase in step (b) is performed at the same time and in the same container, and step (c) is re-use of at least part of the soaking water comprising the immobilized asparaginase to soak several batches of potato pieces. In another preferred embodiment, step (b) is pumping of at least part of the soaking water through a bed or column of immobilized asparaginase at a temperature of above 60° C., preferably above 65° C., more preferably above 70° C., even more preferably at a temperature of at least 75° C. or at least 80° C., and step (c) is re-use of at least part of the asparaginase treated soaking water to soak further batches of potato pieces.

In one embodiment, the food material is potato slices, which are to be fried or baked to produce potato chips.

In another embodiment, the food material is potato slices, which are to be fried or baked to produce potato chips, step (a) is soaking of the potato slices at a temperature of above 60° C., preferably above 65° C., more preferably above 70° C., even more preferably at a temperature of at least 75° C. or at least 80° C., and step (b) is contacting of at least part of the soaking water comprising asparagine with an immobilized asparaginase, such as an immobilized thermostable asparaginase, at a temperature of above 60° C., preferably above 65° C., more preferably above 70° C., even more preferably at a temperature of at least 75° C. or at least 80° C. In one preferred embodiment, the soaking of the potato slices in step (a) and the contacting of the soaking water with immobilized asparaginase in step (b) is performed at the same time and in the same container, and step (c) is re-use of at least part of the soaking water comprising the immobilized asparaginase to soak several batches of potato slices. In another preferred embodiment, step (b) is pumping of at least part of the soaking water through a bed or column of immobilized asparaginase at a temperature of above 60° C., preferably above 65° C., more preferably above 70° C., even more preferably at a temperature of at least 75° C. or at least 80° C., and step (c) is re-use of at least part of the asparaginase treated soaking water to soak further batches of potato slices.

In one embodiment, the food material is potato strips, which are to be fried or baked to produce French fries.

In another embodiment, the food material is potato strips, which are to be fried or baked to produce French fries, step (a) is soaking of the potato strips at a temperature of above 60° C., preferably above 65° C., more preferably above 70° C., even more preferably at a temperature of at least 75° C. or at least 80° C., and step (b) is contacting of at least part of the soaking water comprising asparagine with an immobilized asparaginase, such as an immobilized thermostable asparaginase, at a temperature of above 60° C., preferably above 65° C., more preferably above 70° C., even more preferably at a temperature of at least 75° C. or at least 80° C. In one preferred embodiment, the soaking of the potato strips in step (a) and the contacting of the soaking water with immobilized asparaginase in step (b) is performed at the same time and in the same container, and step (c) is re-use of at least part of the soaking water comprising the immobilized asparaginase to soak several batches of potato strips. In another preferred embodiment, step (b) is pumping of at least part of the soaking water through a bed or column of immobilized asparaginase at a temperature of above 60° C., preferably above 65° C., more preferably above 70° C., even more preferably at a temperature of at least 75° C. or at least 80° C., and step (c) is re-use of at least part of the asparaginase treated soaking water to soak further batches of potato strips.

In one embodiment, the food material comprises cuts of potatoes or other root vegetables such as, but not limited to, carrot, beetroot, parsnip, parsley root and celery root, which are to be fried and/or baked; the food material is treated with pulsed electric field (PEF) before step (a); step (a) is soaking the food material in water at a temperature of below 15° C., preferably below 12° C., more preferably below 10° C.; and step (b) is contacting of at least part of the soaking water comprising asparagine with an immobilized asparaginase at a temperature of below 15° C., preferably below 12° C., more preferably below 10° C. In one preferred embodiment, the soaking of the food material in step (a) and the contacting of the soaking water with immobilized asparagi-nase in step (b) is performed at the same time and in the same container, and step (c) is re-use of at least part of the soaking water comprising the immobilized asparaginase to soak several batches of food material. In another preferred embodiment, step (b) is pumping of at least part of the soaking water through a bed or column of immobilized asparaginase at a temperature of below 15° C., and step (c) is re-use of at least part of the asparaginase treated soaking water to soak further batches of food material.

In one embodiment, the food material is potato pieces, such as potato slices or potato strips, which are to be fried or baked to produce potato chips or French fries; the potato pieces are treated with pulsed electric field (PEF) before step (a); step (a) is soaking the potato pieces in water at a temperature of below 15° C., preferably below 12° C., more preferably below 10° C.; and step (b) is contacting at least part of the soaking water comprising asparagine with an immobilized asparaginase at a temperature of below 15° C., preferably below 12° C., more preferably below 10° C. In one preferred embodiment, the soaking of the potato pieces in step (a) and the contacting of the soaking water with immobilized asparaginase in step (b) is performed at the same time and in the same container, and step (c) is re-use of at least part of the soaking water comprising the immobilized asparaginase to soak several batches of potato pieces. In another preferred embodiment, step (b) is pumping of at least part of the soaking water through a bed or column of immobilized asparaginase at a temperature of below 15° C., and step (c) is re-use of at least part of the asparaginase treated soaking water to soak further batches of potato pieces.

In one embodiment, the food material is potato slices, which are to be fried or baked to produce potato chips; the potato slices are treated with pulsed electric field (PEF) before step (a); step (a) is soaking the potato slices in water at a temperature of below 15° C., preferably below 12° C., more preferably below 10° C.; and step (b) is contacting at least part of the soaking water comprising asparagine with an immobilized asparaginase at a temperature of below 15° C., preferably below 12° C., more preferably below 10° C. In one preferred embodiment, the soaking of the potato slices in step (a) and the contacting of the soaking water with immobilized asparaginase in step (b) is performed at the same time and in the same container, and step (c) is re-use of at least part of the soaking water comprising the immobilized asparaginase to soak several batches of potato slices. In another preferred embodiment, step (b) is pumping of at least part of the soaking water through a bed or column of immobilized asparaginase at a temperature of below 15° C., and step (c) is re-use of at least part of the asparaginase treated soaking water to soak further batches of potato slices.

In one embodiment, the food material is potato strips, which are to be fried or baked to produce French fries; the potato strips are treated with pulsed electric field (PEF) before step (a); step (a) is soaking the potato strips in water at a temperature of below 15° C., preferably below 12° C., more preferably below 10° C.; and step (b) is contacting at least part of the soaking water comprising asparagine with an immobilized asparaginase at a temperature of below 15° C., preferably below 12° C., more preferably below 10° C. In one preferred embodiment, the soaking of the potato strips in step (a) and the contacting of the soaking water with immobilized asparaginase in step (b) is performed at the same time and in the same container, and step (c) is re-use of at least part of the soaking water comprising the immobilized asparaginase to soak several batches of potato strips. In another preferred embodiment, step (b) is pumping of at least part of the soaking water through a bed or column of immobilized asparaginase at a temperature of below 15° C., and step (c) is re-use of at least part of the asparaginase treated soaking water to soak further batches of potato strips.

Food material such as cuts of potatoes or other root vegetables comprises sugar, e.g., glucose and fructose, which will leak into the soaking/blanching water. Removal of glucose and/or fructose will enable even more re-use of the soaking/blanching water.

Therefore, in one embodiment step (b) is contacting at least part of the soaking water comprising asparagine with an immobilized asparaginase and with an immobilized enzyme having a glucose oxidising activity at a temperature where microbial growth is reduced. The enzyme having a glucose oxidising activity may be, e.g., a glucose oxidase. Or it may be, e.g., a carbohydrate oxidase, a lactose oxidase or a cellobiose oxidase which oxidize glucose as well as other mono- and disaccharides.

In another embodiment, step (b) is contacting at least part of the soaking water comprising asparagine with an immobilized asparaginase, with an immobilized enzyme having a glucose oxidising activity and with an immobilized glucose isomerase at a temperature where microbial growth is reduced. A glucose isomerase is an enzyme which catalyzes the reversible isomerization of D-glucose to D-fructose and vice versa. If glucose isomerase is used together with an enzyme having a glucose oxidizing activity, fructose will be isomerized to glucose which will be oxidized to D-glucono-δ-lactone which will be further hydrolysed to gluconic acid in water.

In another embodiment, step (b) is contacting at least part of the soaking water comprising asparagine with an immobilized asparaginase, with an immobilized enzyme having a glucose oxidising activity and with an immobilized catalase at a temperature where microbial growth is reduced. A catalase is an enzyme which catalyzes the decomposition of hydrogen peroxide to water and oxygen. When glucose is enzymatically oxidized by one of the oxidoreductase enzymes mentioned above, hydrogen peroxide and D-glucono-δ-lactone is formed. And it may be an advantage to break down some of the hydrogen peroxide and release some free oxygen.

In yet another embodiment, step (b) is contacting at least part of the soaking water comprising asparagine with an immobilized asparaginase, with an immobilized enzyme having a glucose oxidising activity, with an immobilized glucose isomerase and with an immobilized catalase at a temperature where microbial growth is reduced.

In one embodiment, the food material to be soaked in water comprises green coffee beans which are to be roasted.

Green coffee beans may also be referred to as raw coffee beans or unroasted coffee beans.

In one embodiment, the food material to be soaked is green coffee beans which are to be roasted; step (a) is soaking of the green coffee beans at a temperature of above 60° C., preferably above 65° C., more preferably above 70° C., even more preferably at a temperature of at least 75° C. or at least 80° C.; and step (b) is contacting of at least part of the soaking water comprising asparagine with an immobilized asparaginase, such as an immobilized thermostable asparaginase, at a temperature of above 60° C., preferably above 65° C., more preferably above 70° C., even more preferably at a temperature of at least 75° C. or at least 80°.

In another embodiment, the food material to be soaked is green coffee beans which are to be roasted; step (a) is soaking of the green coffee beans at a temperature of below 15° C., preferably below 12° C., more preferably below 10° C.; and step (b) is contacting of at least part of the soaking water comprising asparagine with an immobilized asparaginase at a temperature of below 15° C., preferably below 12° C., more preferably below 10° C.

In one embodiment, the food material to be soaked is green coffee beans which are to be roasted and the soaking water comprising asparagine is contacted with an immobilized asparaginase by means of a dominant bath.

In succession, several batches of green coffee beans are soaked in water until the soluble materials that extract from the beans are in or near equilibrium with the solution. In one embodiment, the immobilized asparaginase in the dominant bath converts asparagine to aspartic acid, thus creating a driving force for additional asparagine extraction on subsequent additions of batches of beans.

Extractable materials can equilibrate with the beans such that additional soluble coffee components do not extract out, with the exception of asparagine, which continues to react and be converted by the immobilized asparaginase. The aspartic acid that is formed from the asparagine soaks back into the beans and equilibrates. Additional water is added back after every batch of beans to make up for the solution going into the previous batch of beans; this maintains a constant volume of the dominant bath.

In one embodiment, the food material is green coffee beans which are to be roasted; step (b) is pumping of at least part of the soaking water through a bed or column of immobilized asparaginase, such as immobilized thermostable asparaginase, at a temperature of above 60° C.; and step (c) is re-use of at least part of the asparaginase treated soaking water to soak further batches of green coffee beans.

In another embodiment, the food material is green coffee beans which are to be roasted; step (b) is pumping of at least part of the soaking water through a bed or column of immobilized asparaginase at a temperature of below 15° C.; and step (c) is re-use of at least part of the asparaginase treated soaking water to soak further batches of green coffee beans.

In one embodiment, the food material is green coffee beans which are to be roasted; the soaking of the green coffee beans in step (a) and the contacting of the soaking water with immobilized asparaginase in step (b) is performed at the same time and in the same container at a temperature of above 60° C.; and step (c) is re-use of at least part of the soaking water comprising the immobilized asparaginase to soak several batches of green coffee beans.

In another embodiment, the food material is green coffee beans which are to be roasted; the soaking of the green coffee beans in step (a) and the contacting of the soaking water with immobilized asparaginase in step (b) is performed at the same time and in the same container at a temperature of below 15° C.; and step (c) is re-use of at least part of the soaking water comprising the immobilized asparaginase to soak several batches of green coffee beans.

In one embodiment, the food material is green coffee beans which are to be roasted; step (a) is soaking of green coffee beans in water followed by separating the soaked green coffee beans from the soaking water and drying the soaked green coffee beans; step (b) is pumping of at least part of the soaking water through a bed or column of immobilized asparaginase, such as immobilized thermostable asparaginase, at a temperature of above 60° C.; and step (c) is re-use of at least part of the asparaginase treated soaking water by potentially concentrating it and adding it back to the soaked and dried green coffee beans and allowing the beans to imbibe the asparaginase treated and potentially concentrated soaking water.

In another embodiment, the food material is green coffee beans which are to be roasted; step (a) is soaking of green coffee beans in water followed by separating the soaked green coffee beans from the soaking water and drying the soaked green coffee beans; step (b) is pumping of at least part of the soaking water through a bed or column of immobilized asparaginase at a temperature of below 15° C.; and step (c) is re-use of at least part of the asparaginase treated soaking water by potentially concentrating it and adding it back to the soaked and dried green coffee beans and allowing the beans to imbibe the asparaginase treated and potentially concentrated soaking water.

After soaking and before roasting, the green coffee beans may be dried. The green coffee beans may be dried to a moisture content of about 5-15%, preferably 7-12%. Suitable methods of drying can include freeze drying, belt drying, vacuum drying, oven drying, fluid bed drying, and combinations thereof.

Following soaking and optional drying, the coffee beans are roasted to form roasted coffee beans. Any suitable process comprising roasting may be used. As used herein, the term “roasting” includes any suitable thermal treatment of coffee beans to create flavors that are indicative of coffee. Suitable roasting techniques can include, but are not limited to, oven roasting, extrusion roasting, steam roasting (e.g., with no post roasting), infrared roasting, microwave roasting, di-electric/induction heating roasting, and combinations thereof.

The coffee beans can be roasted to any desired roast color. The roast colour can be monitored by different equipment, Hunterlab or Colur Test.

The coffee beans may optionally be ground. The grinding may be performed at any stage such as before or after roasting. Preferably, the grinding is performed after roasting.

The roasted coffee beans can be used as is or can be used to make a variety of roasted coffee products, such as roast and ground coffees, liquid concentrates, instant or powdered coffees, coffee beverages (e.g., hot and cold ready to serve coffees, vended coffees, commercial and at-home brewed coffees, Kahlua™, lattes, cappuccinos), mixes (e.g., cafe latte mixes), confectionaries (e.g., candy), desserts (e.g., cakes, ice creams, mousses, custards), pastries (e.g., Danish, donuts), sauces, and soups (e.g., chili). In one embodiment, the coffee beans are dried, roasted, then ground to form roast and ground coffee.

### Asparaginase

An asparaginase in the context of the present invention means an enzyme having asparaginase activity, i.e., an enzyme that catalyzes the hydrolysis of asparagine to aspartic acid (EC 3.5.1.1).

Asparaginase activity may, e.g., be determined according to the asparaginase activity (ASNU) assay described in Example 1. In one embodiment, an asparaginase to be used in the method of the present invention has at least 20%, e.g., at least 40%, at least 50%, at least 60%, at least 70%, at least 80%, at least 90%, at least 95%, or at least 100% of the asparaginase activity of the mature polypeptide of SEQ ID NO: 1 when measured at pH 7 and at 37° C.

Asparaginase activity may also be determined, e.g., according to the phenol activity assay described in Example 2. This assay may be better for determining the asparaginase activity of a thermostable asparaginase. In one embodiment, an asparaginase to be used in the method of the present invention is a thermostable asparaginase having at least 20%, e.g., at least 40%, at least 50%, at least 60%, at least 70%, at least 80%, at least 90%, at least 95%, or at least 100% of the asparaginase activity of the mature polypeptide of SEQ ID NO: 2 when measured according to the phenol activity assay described in Example 2.

The asparaginase activity may be determined per gram enzyme sample.

The asparaginase may be obtained from any source, e.g., from a microorganism, from a plant or from an animal.

The asparaginase may be obtained from a microorganism of any genus, e.g., from a bacterium, an archaeon or a fungus. For purposes of the present invention, the term “obtained from” as used herein in connection with a given source shall mean that the asparaginase encoded by a polynucleotide is produced by the source or by a strain in which the polynucleotide from the source has been inserted.

It may be a wild type asparaginase, i.e., an asparaginase found in nature, or it may be a variant asparaginase, i.e., an asparaginase comprising an alteration, i.e., a substitution, insertion, and/or deletion, at one or more (e.g., several) positions compared to a parent asparaginase from which it may have been derived. A substitution means replacement of the amino acid occupying a position with a different amino acid; a deletion means removal of the amino acid occupying a position; and an insertion means adding an amino acid adjacent to and immediately following the amino acid occupying a position.

The asparaginase or its parent may be a bacterial asparaginase. For example, the asparaginase may be a Gram-positive bacterial asparaginase such as a Bacillus, Clostridium, Enterococcus, Geobacillus, Lactobacillus, Lactococcus, Oceanobacillus, Staphylococcus, Streptococcus, or Streptomyces asparaginase, or a Gram-negative bacterial asparaginase such as a Campylobacter, E. coli, Flavobacterium, Fusobacterium, Helicobacter, Ilyobacter, Neisseria, Pseudomonas, Salmonella, or Ureaplasma asparaginase.

In one embodiment, the asparaginase is a Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, or Bacillus thuringiensis asparaginase.

In another embodiment, the asparaginase is a Streptococcus equisimilis, Streptococcus pyogenes, Streptococcus uberis, or Streptococcus equi subsp. Zooepidemicus asparaginase.

In another embodiment, the asparaginase is a Streptomyces achromogenes, Streptomyces avermitilis, Streptomyces coelicolor, Streptomyces griseus, or Streptomyces lividans asparaginase.

The asparaginase or its parent may be a fungal asparaginase. For example, the asparaginase may be a yeast asparaginase such as a Candida, Kluyveromyces, Pichia, Saccharomyces, Schizosaccharomyces, or Yarrowia asparaginase; or a filamentous fungal asparaginase such as an Acremonium, Agaricus, Alternaria, Aspergillus, Aureobasidium, Botryosphaeria, Ceriporiopsis, Chaetomidium, Chrysosporium, Claviceps, Cochliobolus, Coprinopsis, Coptotermes, Corynascus, Cryphonectria, Cryptococcus, Diplodia, Exidia, Filibasidium, Fusarium, Gibberella, Holomastigotoides, Humicola, Irpex, Lentinula, Leptospaeria, Magnaporthe, Melanocarpus, Meripilus, Mucor, Myceliophthora, Neocallimastix, Neurospora, Paecilomyces, Penicillium, Phanerochaete, Piromyces, Poitrasia, Pseudoplectania, Pseudotrichonympha, Rhizomucor, Schizophyllum, Scytalidium, Talaromyces, Thermoascus, Thielavia, Tolypocladium, Trichoderma, Trichophaea, Verticillium, Volvariella, or Xylaria asparaginase.

In one embodiment, the asparaginase is a Saccharomyces carlsbergensis, Saccharomyces cerevisiae, Saccharomyces diastaticus, Saccharomyces douglasfi, Saccharomyces kluyveri, Saccharomyces norbensis, or Saccharomyces oviformis asparaginase.

In another embodiment, the asparaginase is an Acremonium cellulolyticus, Aspergillus aculeatus, Aspergillus awamori, Aspergillus foetidus, Aspergillus fumigatus, Aspergillus japonicus, Aspergillus nidulans, Aspergillus niger, Aspergillus oryzae, Chrysosporium inops, Chrysosporium keratinophilum, Chrysosporium lucknowense, Chrysosporium merdarium, Chrysosporium pannicola, Chrysosporium queenslandicum, Chrysosporium tropicum, Chrysosporium zonaturn, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola grisea, Humicola insolens, Humicola lanuginosa, Irpex lacteus, Mucor miehei, Myceliophthora thermophila, Neurospora crassa, Penicillium funiculosum, Penicillium purpurogenum, Phanerochaete chrysosporium, Thielavia achromatica, Thielavia albomyces, Thielavia albopilosa, Thielavia australeinsis, Thielavia fimeti, Thielavia microspora, Thielavia ovispora, Thielavia peruviana, Thielavia setosa, Thielavia spededonium, Thielavia subthermophila, Thielavia terrestris, Trichoderma harzianurn, Trichoderma koningii, Trichoderma longibrachiatum, Trichoderma reesei, or Trichoderma viride asparaginase.

It will be understood that for the aforementioned species, the invention encompasses both the perfect and imperfect states, and other taxonomic equivalents, e.g., anamorphs, regardless of the species name by which they are known. Those skilled in the art will readily recognize the identity of appropriate equivalents.

Strains of these species are readily accessible to the public in a number of culture collections, such as the American Type Culture Collection (ATCC), Deutsche Sammlung von Mikroorganismen and Zellkulturen GmbH (DSMZ), Centraalbureau Voor Schimmelcultures (CBS), and Agricultural Research Service Patent Culture Collection, Northern Regional Research Center (NRRL).

The asparaginase may be identified and obtained from other sources including microorganisms isolated from nature (e.g., soil, composts, water, etc.) or DNA samples obtained directly from natural materials (e.g., soil, composts, water, etc.). Techniques for isolating microorganisms and DNA directly from natural habitats are well known in the art. A polynucleotide encoding the asparaginase may then be obtained by similarly screening a genomic DNA or cDNA library of another microorganism or mixed DNA sample. Once a polynucleotide encoding an asparaginase has been detected, the polynucleotide can be isolated or cloned by utilizing techniques that are known to those of ordinary skill in the art (see, e.g., Sambrook et al., 1989, Molecular Cloning, A Laboratory Manual, 2d edition, Cold Spring Harbor, New York).

The asparaginase or its parent may be obtained from Aspergillus, e.g., from Aspergillus aculeatus, Aspergillus awamori, Aspergillus foetidus, Aspergillus fumigatus, Aspergillus japonicus, Aspergillus nidulans, Aspergillus niger, Aspergillus oryzae or Aspergillus terreus.

The asparaginase or its parent may be obtained from Aspergillus oryzae, e.g., the asparaginase of SEQ ID NO: 1 or the mature polypeptide thereof.

The asparaginase may have at least 50% sequence identity to the mature polypeptide of SEQ ID NO: 1, such as at least 60%, at least 70%, at least 80%, at least 90%, at least 95% or at least 98% sequence identity to the mature polypeptide of SEQ ID NO: 1.

SEQ ID NO: 1 is the amino acid sequence of asparaginase from Aspergillus oryzae.

In the context of the present invention, the term “mature polypeptide” means a polypeptide in its final form following translation and any post-translational modifications, such as N-terminal processing, C-terminal truncation, glycosylation, phosphorylation, etc. It is known in the art that a host cell may produce a mixture of two of more different mature polypeptides (i.e., with a different C terminal and/or N terminal amino acid) expressed by the same polynucleotide.

Based on N-terminal sequencing and mass spectrometry (MS) analysis, it seems that N-terminal processing of the asparaginase of SEQ ID NO: 1 is quite heterogeneous. In one embodiment, the mature polypeptide is amino acids 20 to 378 of SEQ ID NO: 1 based on SignalP (Nielsen et al., 1997, Protein Engineering 10: 1-6) that predicts that amino acids 1 to 19 of SEQ ID NO: 1 are a signal peptide.

For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the −nobrief option) is used as the percent identity and is calculated as follows:

(Identical Residues×100)/(Length of Alignment−Total Number of Gaps in Alignment)

The asparaginase may be a variant of a parent asparaginase having at least 50% sequence identity to the mature polypeptide of SEQ ID NO: 1, such as at least 60%, at least 70%, at least 80%, at least 90%, at least 95% or at least 98% sequence identity to the mature polypeptide of SEQ ID NO: 1.

In one embodiment, the asparaginase has an alteration, i.e., a substitution, insertion, and/or deletion, at one or more (e.g., several) positions of the mature polypeptide of SEQ ID NO: 1. In one embodiment, the number of amino acid substitutions, deletions and/or insertions introduced into the mature polypeptide of SEQ ID NO: 1 is up to 10, e.g., 1, 2, 3, 4, 5, 6, 7, 8, 9, or 10.

In a preferred embodiment, the asparaginase is a thermostable asparaginase.

A thermostable enzyme in the context of the present invention may be defined as an asparaginase, which after incubation at 70° C. for 10 minutes has a residual activity of at least 75%. The residual activity may be measured according to the phenol activity assay described in Example 2.

The asparaginase or its parent may be obtained from Pyrococcus furiosus, e.g., the asparaginase of SEQ ID NO: 2 or the mature polypeptide thereof.

The asparaginase may have at least 50% sequence identity to the mature polypeptide of SEQ ID NO: 2, such as at least 60%, at least 70%, at least 80%, at least 90%, at least 95% or at least 98% sequence identity to the mature polypeptide of SEQ ID NO: 2.

In one embodiment, the asparaginase has an alteration, i.e., a substitution, insertion, and/or deletion, at one or more (e.g., several) positions of the mature polypeptide of SEQ ID NO: 2. In one embodiment, the number of amino acid substitutions, deletions and/or insertions introduced into the mature polypeptide of SEQ ID NO: 2 is up to 10, e.g., 1, 2, 3, 4, 5, 6, 7, 8, 9, or 10.

SEQ ID NO: 2 is the amino acid sequence of thermostable asparaginase from Pyrococcus furiosus. Based on N-terminal sequencing and mass spectrometry (MS) analysis, the mature polypeptide is amino acids 1 to 326 of SEQ ID NO: 2.

The asparaginase or its parent may be obtained from Thermococcus sibiricus, e.g., the asparaginase of SEQ ID NO: 3 or the mature polypeptide thereof.

The asparaginase may have at least 50% sequence identity to the mature polypeptide of SEQ ID NO: 3, such as at least 60%, at least 70%, at least 80%, at least 90%, at least 95% or at least 98% sequence identity to the mature polypeptide of SEQ ID NO: 3.

In one embodiment, the asparaginase has an alteration, i.e., a substitution, insertion, and/or deletion, at one or more (e.g., several) positions of the mature polypeptide of SEQ ID NO: 3. In one embodiment, the number of amino acid substitutions, deletions and/or insertions introduced into the mature polypeptide of SEQ ID NO: 3 is up to 10, e.g., 1, 2, 3, 4, 5, 6, 7, 8, 9, or 10.

SEQ ID NO: 3 is the amino acid sequence of thermostable asparaginase from Thermococcus sibiricus. Based on N-terminal sequencing and mass spectrometry (MS) analysis, the mature polypeptide is amino acids 1 to 331 of SEQ ID NO: 3.

The asparaginase or its parent may be obtained from Thermococcus gammatolerans, e.g., the asparaginase of SEQ ID NO: 4 or the mature polypeptide thereof.

The asparaginase may have at least 50% sequence identity to the mature polypeptide of SEQ ID NO: 4, such as at least 60%, at least 70%, at least 80%, at least 90%, at least 95% or at least 98% sequence identity to the mature polypeptide of SEQ ID NO: 4.

In one embodiment, the asparaginase has an alteration, i.e., a substitution, insertion, and/or deletion, at one or more (e.g., several) positions of the mature polypeptide of SEQ ID NO: 4. In one embodiment, the number of amino acid substitutions, deletions and/or insertions introduced into the mature polypeptide of SEQ ID NO: 4 is up to 10, e.g., 1, 2, 3, 4, 5, 6, 7, 8, 9, or 10.

SEQ ID NO: 4 is the amino acid sequence of thermostable asparaginase from Thermococcus gammatolerans. Based on N-terminal sequencing and mass spectrometry (MS) analysis, the mature polypeptide is amino acids 1 to 328 of SEQ ID NO: 4.

The asparaginase or its parent may be obtained from Thermococcus kodakaraensis, e.g., the asparaginase of SEQ ID NO: 5 or the mature polypeptide thereof.

The asparaginase may have at least 50% sequence identity to the mature polypeptide of SEQ ID NO: 5, such as at least 60%, at least 70%, at least 80%, at least 90%, at least 95% or at least 98% sequence identity to the mature polypeptide of SEQ ID NO: 5.

In one embodiment, the asparaginase has an alteration, i.e., a substitution, insertion, and/or deletion, at one or more (e.g., several) positions of the mature polypeptide of SEQ ID NO: 5. In one embodiment, the number of amino acid substitutions, deletions and/or insertions introduced into the mature polypeptide of SEQ ID NO: 5 is up to 10, e.g., 1, 2, 3, 4, 5, 6, 7, 8, 9, or 10.

SEQ ID NO: 5 is the amino acid sequence of thermostable asparaginase from Thermococcus kodakaraensis. Based on N-terminal sequencing and mass spectrometry (MS) analysis, the mature polypeptide is amino acids 1 to 328 of SEQ ID NO: 5.

### EXAMPLES

### Example 1

### Asparaginase Activity (ASNU) Assay

The activity of asparaginase may be measured in ASNU. An asparaginase unit (ASNU) is defined as the amount of enzyme needed to generate 1.0 micromole of ammonia in 1 minute at 37° C. and pH 7.0, in 0.1 M 3-(N-morpholino)propanesulfonic acid buffer (MOPS) with 9.2 mg/ml asparagine.

Asparaginase hydrolyzes asparagine to aspartic acid and ammonium. The produced ammonium is combined with α-ketoglutarate to form glutamic acid whereby NADH is oxidized to NAD+. The reaction is catalysed by a surplus of glutamate dehydrogenase. The consumption of NADH is measured by photometry at 340 nm. NADH has an absorbance at 340 nm, while NAD+ has no absorbance. A decrease in color is thus measured, and can be correlated to asparaginase activity.

Activity is determined relative to an asparaginase standard of known activity. A commercial product having a declared activity like Acrylaway® L may be used as standard (Acrylaway® L is commercially available from Novozymes NS, Denmark).

### Example 2

### Phenol Activity Assay for Quantification of Thermostable Asparaginase

### Principle

Asparaginase activity was determined in two steps. The first step is an enzymatic step where ammonia is formed by the catalytic action of the asparaginase from asparagine. The second step is a non-enzymatic detection step wherein the formed ammonia is derivatized to a blue indophenol compound.

### Enzyme

Asparaginase from Pyrococcus furiosus disclosed in WO2008/151807 was used in free and immobilized form. The enzyme was immobilized on a silica based carrier by a one-step impregnation and subsequent cross-linking by glutaraldehyde and polyethylene imine using the principle as described in example 2 in WO2007/036235.

### Enzyme and Standard Incubation

Immobilized asparaginase: 25 mg immobilized asparaginase was incubated with 50 mL asparagine solution in a waterbath at 80° C., 202 rpm for 10 min. The reaction was stopped by addition of 50 μL 1.5 M trichloroacetic acid (TCA) to 1 mL supernatant.

Standard and free asparaginase: Ammonium chloride was used as standard in the range of 0 mM to 10 mM. 20 μL ammonium standard or appropriately diluted free asparaginase in buffer was incubated with 100 μL asparagine solution in a PCR machine at 80° C. for 10 min. The reaction was stopped by addition of 20 μL 1.5 M TCA.

Asparagine solution: Asparagine (10 g/L) is dissolved in 100 mM Briton Robinson buffer (100 mM sodium acetate, 100 mM phosphate, 100 mM borate and 0.01% Triton X-100 at pH 7).

### Quantification

Three different color reagents are needed:
A—4% (w/v) Phenol, 0.015% (w/v) sodium pentacyanonitrosylferrate (III) dihydrate (Na₂[Fe(CN)₅NO]2H₂O),
B—5% (w/v) Potassium hydroxide, and
C—28% (w/v) Potassium carbonate, 6% (v/v) sodium hypochlorite.

60 μL of the samples is transferred to a new MicroTiterPlate (MTP). To each well, 60 μL of color reagent A is added (shake gently to mix). To each well, 30 μL of color reagent B is added (shake gently to mix). To each well, 60 μL of color reagent C is added (shake gently to mix). Carefully seal the plate and incubate for 20 minutes at 37° C., 750 rpm on an Eppendorf thermomixer equipped with an MTP adapter. The absorbance is measured at 630 nm. The absorbance of the standard solutions is plotted as a function of NH₄⁺ concentration, and the produced ammonium in the samples calculated based on this. 1U is equal to 1 μmol NH₄⁺ released per minute. The final immobilization unit is called U 80/g carrier. The free asparaginase unit is called U 80/mL.

Testing the immobilized asparaginase gave an activity of ˜28,000 U 80/g carrier.

Testing free asparaginase gave an activity of ˜38,000 U 80/mL.

### Example 3

### Application Assay

### Potato Blanching

### Amino Acid Analysis

Asparagine and aspartic acid content of samples were analyzed on a ThermoFisher WPS3000 high pressure liquid chromatography system comprising a quaternary pump, an auto sampler with temperature control, a column oven and a tunable fluorescence detector. Prior to the analysis, samples have been filtered with 0.22 μm PVDF filter. Samples were analyzed after automated pre-column derivatisation. 30 μL milli-Q water, 10 μL of 0.4 M borate buffer pH 10.2, 2 μL sample, and 2 μL ortho-phthalaldehyde 10 g/L in 0.4 M borate buffer pH 10.2 were collected and mixed by pipetting up and down in a mixing vial. 100 μL milli-Q water was added, and 2 μL was finally injected for chromatographic analysis on a Agilent zorbax eclipse AAA column (4.6 mm by 150 mm, 3.5 μm particle size) with the corresponding guard column.

The pump was set to a constant flow rate of 2 ml/minute, the column was initially equilibrated with 20 mM phosphate buffer pH 7.5 eluting aspartic acid, while asparagine was eluted with a linear gradient from 4 minutes to 12 minutes up to 100% of a 45% methanol 45% acetonitrile 10% water mixture. Fluorescence of the asparagine and aspartic acid derivative was exited with light at 340 nm and emission was quantified at 450 nm. Samples were analyzed by comparison to standard aspartic acid and asparagine in the concentration range from 0.05 mM to 0.75 mM.

### Application Assay

The efficiency of immobilized asparaginase, free asparaginase and a control (no enzyme) during potato blanching has been compared in a potato diffusion application set up running at 80° C. The performance was measured by analyzing asparagine to aspartic acid conversion in the blanching water.

Chipping potatoes (Saturna) were manually peeled, and cut into French fries (size 0.8×0.8×5 cm) using a French fry cutter (Coupe Frites) and afterwards chopped into small cubes. The potato pieces were mixed and held in de-ionized water until use (30 min). The blanching water was pre-heated to 80° C. 60 g potato pieces were applied in a perforated metal jar and added to 400 mL hot blanching water with magnet stirring. The immobilized asparaginase was added to the blanching water in a teabag while the free asparaginase was simply added to the blanching water; both enzymes were added prior to the addition of the potatoes. The immobilized enzyme and the free enzyme were dosed ˜35,000 U 80/L blanching water.

The incubation time per potato batch was 10 min. After 10 min, the blanched potatoes were replaced with fresh potatoes and this step was repeated once more after 10 min with no change of the blanching water; this means a total running time of 30 min. Every time fresh potatoes were added into the blanching water, samples from the blanching water were taken at 1, 3, 5, 7.5 and 10 min for measuring asparagine and aspartic acid. To 500 μL blanching water 25 μL 1 M HCl was added to inactivate the enzyme. This sampling was carried out for the immobilized asparaginase, free asparaginase and the control (no enzyme).

TABLE 1
Asparagine and aspartic acid conversion in the blanching water of
the control, immobilized asparaginase and free asparaginase is presented
as the ratio of Asn or Asp of the sum of Asn and Asp

| | | | Immobilized | | | |
|---|---|---|---|---|---|---|
| | Control | | asparaginase | | Free asparaginase | |
| Total time, min | Asn | Asp | Asn | Asp | Asn | Asp |
| 0 | | | | | | |

Potato addition

| | | | | | | |
|---|---|---|---|---|---|---|
| 1 | 0.83 | 0.17 | 0.87 | 0.13 | 0.21 | 0.79 |
| 3 | 0.86 | 0.14 | 0.87 | 0.13 | 0.20 | 0.80 |
| 5 | 0.91 | 0.09 | 0.85 | 0.15 | 0.20 | 0.80 |
| 7.5 | 0.91 | 0.09 | 0.83 | 0.17 | 0.20 | 0.80 |
| 10 | 0.91 | 0.09 | 0.79 | 0.21 | 0.20 | 0.80 |

Potato change

| | | | | | | |
|---|---|---|---|---|---|---|
| 11 | 0.90 | 0.10 | 0.79 | 0.21 | 0.21 | 0.79 |
| 13 | 0.90 | 0.10 | 0.80 | 0.20 | 0.21 | 0.79 |
| 15 | 0.91 | 0.09 | 0.79 | 0.21 | 0.21 | 0.79 |
| 17.5 | 0.91 | 0.09 | 0.78 | 0.22 | 0.21 | 0.79 |
| 20 | 0.92 | 0.08 | 0.76 | 0.24 | 0.22 | 0.78 |

Potato change

| | | | | | | |
|---|---|---|---|---|---|---|
| 21 | 0.91 | 0.09 | 0.75 | 0.25 | 0.22 | 0.78 |
| 23 | 0.92 | 0.08 | 0.77 | 0.23 | 0.22 | 0.78 |
| 25 | 0.92 | 0.08 | 0.77 | 0.23 | 0.22 | 0.78 |
| 27.5 | 0.92 | 0.08 | 0.76 | 0.24 | 0.22 | 0.78 |
| 30 | 0.92 | 0.08 | 0.74 | 0.26 | 0.22 | 0.78 |

As seen from the table, the immobilized asparaginase converts asparagine to aspartic acid over the incubation time and thereby lowering the relative ratio of asparagine while the relative ratio of aspartic acid is increasing compared to the control sample, which indicates that the immobilized asparaginase is active in the blanching water.

Comparing the performance of immobilized asparaginase to free asparaginase, it can be seen that free asparaginase is more active; the relative ratio of aspartic acid is three times higher compared to asparagine.

### Example 4

### Testing Immobilized Asparaginase in a Column Set-Up

A column set-up was established to allow testing of immobilized asparaginase in a continuous system. A peristaltic pump delivered substrate to the column which was packed with immobilized asparaginase. The column was either placed in a water bath or heated using a heat cap connected to a water bath, which assured that the set temperature value was maintained throughout the testing. The column, containing immobilized asparaginase, had tubing attached to the outlet allowing sampling.

a) Testing Immobilized Asparaginase with Asparagine Solution

The column was packed with 0.37 g immobilized asparaginase having an activity of 21000 U80/g. Asparagine solution (10 mg/mL) was used as substrate and was added to the column with immobilized asparaginase at 80° C. with different flow rates. Samples were collected and were immediately inactivated with acid (final concentration 0.1M HCl) to inactivate potentially eluted enzyme. Amino acid analysis measuring asparagine (Asn) removal and aspartic acid (Asp) increase was done as written above.

TABLE 2
Different flows applied to the immobilized asparaginase
(0.37 g) and the results are presented as the ratio
of Asn or Asp of the sum of Asn and Asp

| Flow, mL/min | Asn | Asp |
|---|---|---|
| 8 | 0.33 | 0.67 |
| 8 | 0.30 | 0.70 |
| 10 | 0.33 | 0.67 |
| 10 | 0.38 | 0.62 |
| 12 | 0.49 | 0.51 |
| 12 | 0.48 | 0.52 |
| 15 | 0.58 | 0.42 |
| 20 | 0.78 | 0.22 |

The conversion rate is strongly dependent on the flow applied. At flow rates between 8 to 20 mL/min and at a temperature of 80° C., the immobilized asparaginase is able to convert at least 20% of a 10 mg/mL Asn solution. At flow rates of 8 to 10 mL/min and at a temperature of 80° C., as much as 60-70% of a 10 mg/mL Asn solution is converted.

b) Testing Immobilized Asparaginase with Blanching Water

Chipping potatoes (2 mm) was blanched at 80° C. for 3.5 min at a potato water ratio of 200 g/L. The blanching water was centrifuged at 3000 g for 15 min and filtered (Whatman filter). This blanching water was used as substrate for testing immobilized asparaginase. The column was packed with 0.37 g immobilized asparaginase having an activity of 21000 U80/g Different flows and temperatures have been tested to evaluate immobilized asparaginase for its asparagine conversion. Samples were collected and were immediately inactivated with acid (final concentration 0.1 M HCl) to inactivate potentially eluted enzyme. Amino acid analysis measuring asparagine (Asn) removal and aspartic acid (Asp) increase was done as written above.

TABLE 3
Different flows and temperatures applied to the immobilized
asparaginase (0.37 g) and the results are presented as
the ratio of Asn or Asp of the sum of Asn and Asp.

| Flow, mL/min | Temperature, ° C. | Asn | Asp |
|---|---|---|---|
| 4.1 | 60 | 0.21 | 0.79 |
| 4.1 | 60 | 0.17 | 0.83 |
| 4.1 | 60 | 0.18 | 0.82 |
| 4.1 | 60 | 0.06 | 0.94 |
| 5.1 | 60 | 0.12 | 0.88 |
| 6.1 | 60 | 0.31 | 0.69 |
| 4.1 | 60 | 0.22 | 0.78 |
| 4.1 | 70 | 0.04 | 0.96 |
| 4.1 | 70 | 0.05 | 0.95 |
| 4.8 | 70 | 0.13 | 0.87 |
| 5.1 | 70 | 0.27 | 0.73 |
| 5.2 | 70 | 0.19 | 0.81 |
| 6.1 | 70 | 0.10 | 0.90 |
| 6.1 | 70 | 0.21 | 0.79 |
| 4.0 | 80 | 0.12 | 0.88 |
| 4.1 | 80 | 0.03 | 0.97 |
| 5.1 | 80 | 0.07 | 0.93 |
| 5.1 | 80 | 0.24 | 0.76 |
| 6.1 | 80 | 0.14 | 0.86 |
| 6.1 | 80 | 0.28 | 0.72 |

Applying flow rates around 4 to 6 mL/min and temperatures between 60 to 80° C. resulted in asparagine removal of more than 70%.

c) Testing Immobilized Asparaginase with Asparagine Solution Over a 2-Week Period

The column was packed with 5 g immobilized asparaginase having an activity of 21000 U80/g. Asparagine solution (10 mg/mL) was used as substrate and was added to the column with the immobilized asparaginase at 65° C. with a fixed flow rate of 0.8 mL/min. This testing was done over a time period of 2 weeks. As a control, a parallel set-up was established where immobilization carrier was used in the column instead of immobilized asparaginase. During the 2 weeks, samples were collected and immediately inactivated with acid (final concentration 0.1M HCl) to inactivate potentially eluted enzyme. Amino acid analysis measuring asparagine (Asn) removal and aspartic acid (Asp) increase was done as written above. Furthermore, samples that were not inactivated were collected to determine if any enzyme may have leaked from the immobilized product.

TABLE 4
Results showing actual measured flow, sampling time, amino
acid conversion presented as the ratio of Asn or Asp of
the sum of Asn and Asp and enzyme leakage in U80/mL

| Actual flow, | | | | Enzyme leakage, |
|---|---|---|---|---|
| mL/min | Sampling time, h | Asn | Asp | U80/mL |
| 0.94 | 2.00 | 0.06 | 0.94 | 0.1 |
| 0.94 | 6.33 | 0.00 | 1.00 | 0.6 |
| 0.89 | 24.33 | 0.00 | 1.00 | 0 |
| 0.90 | 29.32 | 0.09 | 0.91 | 0.1 |
| 0.85 | 96.03 | 0.00 | 1.00 | 0 |
| 0.83 | 118.80 | 0.00 | 1.00 | — |
| 0.81 | 142.58 | 0.00 | 1.00 | — |
| 0.82 | 168.17 | 0.00 | 1.00 | 0 |
| 0.81 | 191.92 | 0.00 | 1.00 | — |
| 0.81 | 263.00 | 0.00 | 1.00 | — |
| 0.81 | 286.92 | 0.00 | 1.00 | 0.1 |
| 0.80 | 335.08 | 0.00 | 1.00 | 0.1 |
| 0.79 | 358.67 | 0.00 | 1.00 | 0.1 |

The results show that almost all asparagine has been removed by the immobilized asparaginase. With regard to enzyme leakage, asparaginase is very well cross-linked to the carrier material as barely any asparaginase activity could be measured in the eluted samples. In the parallel set-up, where carrier material is used in the column instead of immobilized asparaginase, the results showed that none of the asparagine is converted to aspartic acid.

1. A method for reducing the level of asparagine in a food material to be heat-treated comprising:
(a) soaking the food material in water to extract asparagine;
(b) contacting at least part of the soaking water comprising asparagine with an immobilized asparaginase at a temperature where microbial growth is reduced; and
(c) re-using at least part of the asparaginase treated soaking water.

2. The method of claim 1, wherein the asparagine extracted food material is subjected to a heat treatment.

3. The method of claim 1, wherein step (b) is performed at a temperature where microbial growth is at least 50% reduced compared to 37° C.

4. The method claim 1, wherein step (b) is performed at a temperature of above 60° C.

5. The method of claim 1, wherein the food material is potato pieces, such as potato slices or potato strips, which are to be fried or baked to produce potato chips or French fries.

6. The method of claim 5, wherein step (a) is soaking of the potato pieces at a temperature of above 60° C.

7. The method of claim 6, wherein the soaking of the potato pieces in step (a) and the contacting of the soaking water with immobilized asparaginase in step (b) is performed at the same time and in the same container, and wherein step (c) is re-use of at least part of the soaking water comprising the immobilized asparaginase to soak several batches of potato pieces.

8. The method of claim 6, wherein step (b) is pumping of at least part of the soaking water through a bed or column of immobilized asparaginase at a temperature of above 60° C., and wherein step (c) is re-use of at least part of the asparaginase treated soaking water to soak further batches of potato pieces.

9. The method of claim 1, wherein the food material is potato pieces, such as potato slices or potato strips, which are to be fried or baked to produce potato chips or French fries; wherein the potato pieces are treated with pulsed electric field (PEF) before step (a); and wherein step (b) is contacting at least part of the soaking water comprising asparagine with an immobilized asparaginase at a temperature of below 15° C.

10. The method of claim 9, wherein the soaking of the potato pieces in step (a) and the contacting of the soaking water with immobilized asparaginase in step (b) is performed at the same time and in the same container, and wherein step (c) is re-use of at least part of the soaking water comprising the immobilized asparaginase to soak several batches of potato pieces.

11. The method of claim 5, wherein step (b) is contacting at least part of the soaking water comprising asparagine with an immobilized asparaginase and with an immobilized enzyme having a glucose oxidising activity at a temperature where microbial growth is reduced.

12. The method of claim 1, wherein the food material is green coffee beans which are to be roasted.

13. The method of claim 12, wherein step (b) is pumping of at least part of the soaking water through a bed or column of immobilized asparaginase at a temperature of above 60° C.; and step (c) is re-use of at least part of the asparaginase treated soaking water to soak further batches of green coffee beans.

14. The method of claim 1, wherein the asparaginase is a thermostable asparaginase.

15. The method of claim 1, wherein the immobilized asparaginase is used for continuous treatment of more than 2 tons of soaking water per kg asparaginase.
